(19) United States
(12) Patent Application Publication
(10) Pub. No.: US 2016/0109016 A1
(43) Pub. Date: Apr. 21, 2016

(54) JOINING STRUCTURE OF POWER SOURCE AND TRANSMISSION

(71) Applicant: AISIN SEIKI KABUSHIKI KAISHA, Kariya-shi (JP)

(72) Inventors: Guowang FU, Nagoya-shi (JP); Hideaki NIIMI, Kariya-shi (JP); Takaya UCHIDA, Okazaki-shi (JP)

(73) Assignee: AISIN SEIKI KABUSHIKI KAISHA, Kariya-shi (JP)

(21) Appl. No.: 14/884,907

(22) Filed: Oct. 16, 2015

(30) Foreign Application Priority Data
Oct. 17, 2014 (JP) 2014-212744

(51) Int. Cl. F16H 57/025; F16D 1/033

(52) U.S. Cl. CPC F16H 57/025; F16D 1/033

(57) ABSTRACT

A joining structure of a power source and a transmission includes a joining portion joining a power source and a transmission to each other, the joining portion includes a first fitting portion centering a first housing and a second housing with each other, a second fitting portion where a rotary portion of the transmission is fitted to an output shaft portion of the power source, a housing spacer fixed to the first housing, and a third fitting portion including a protruding portion and a recessed portion, the recessed portion fitted to the protruding portion and centering the second housing and the housing spacer with each other, wherein in a case where the transmission is at a position where the protruding portion and the recessed portion start fitting to each other, the rotary portion is away from a position at which the rotary portion starts fitting to the output shaft portion.

### CROSS REFERENCE TO RELATED APPLICATIONS

This application is based on and claims priority under 35 U.S.C. § 119 to Japanese Patent Application 2014-212744, filed on Oct. 17, 2014, the entire content of which is incorporated herein by reference.

### TECHNICAL FIELD

This disclosure generally relates to a joining structure of a power source and a transmission.

### BACKGROUND DISCUSSION

According to a known joining structure of a power source and a transmission, a housing at a transmission-side is centered with respect to an engine flywheel housing at a drive source-side by spigot joint specifications and then the housing at the transmission-side is attached to the engine flywheel housing (SAE J617 “ENGINE FLYWHEEL HOUSING AND MATING TRANSMISSION HOUSING FLANGES” Society of Automotive Engineers, Inc. Revised in May 1992, which will be referred to as Non-patent document 1).

A known joining structure 10 of a power source and a transmission based on the above-described specifications will be explained with reference to FIGS. 13 and 14. According to the known joining structure 10, a power source is an engine (not shown) and a transmission is a torque converter type transmission (not shown), and the structure of joining the transmission to the power source is provided with a first spigot joint fitting portion 13 which performs centering of an engine housing 11 and a transmission housing 12 with each other. At the first spigot joint fitting portion 13, a first spigot joint flange 13b which is to be fitted to a first spigot joint hole 13a provided at the engine housing 11 is provided at the transmission housing 12. In addition, the known joining structure 10 is provided with a second spigot joint fitting portion 16 which performs centering of a crankshaft portion 14 of the engine and a rotary portion 15 of the transmission with each other. At the second spigot joint fitting portion 16, a second spigot joint flange 16b which is to be fitted to a second spigot joint hole 16a provided at the crankshaft portion 14 is provided at the rotary portion 15 of the transmission.

Specifically, the crankshaft portion 14 corresponds to a structure at which a flywheel 18, a drive plate 19, a reinforce plate 20 and a shim 21 are fixedly fastened together with one another to a crankshaft 17 of the engine with a fastening bolt 22. The second spigot joint hole 16a is provided at the shim 21. The rotary portion 15 of the transmission includes a front cover 23 of the torque converter and the second spigot joint flange 16b is provided at the front cover 23. The centering is conducted by the first spigot joint fitting portion 13 and the second spigot joint fitting portion 16 as illustrated in FIG. 13. After the centering is conducted by the first spigot joint fitting portion 13 and the second spigot joint fitting portion 16, the engine housing 11 and the transmission housing 12 are fastened to each other with a fastening bolt 24 and the drive plate 19 and the front cover 23 are fastened to each other with a fastening bolt 25 as illustrated in FIG. 14, and accordingly the engine and the transmission are joined to each other. In consequence, the power source and the transmission are joined to each other at the housings and at the rotary portion.

However, at the known structure described above, specifications of the first spigot joint fitting portion 13 include a larger diameter than the second spigot joint fitting portion 16, and a length of the first spigot joint fitting portion 13 in an axial-direction is set to be shorter than the second spigot joint fitting portion 16 to assure a centering accuracy. Thus, according to the known structure, a length of the second spigot joint fitting portion 16 in the axial-direction is longer than the first spigot joint fitting portion 13. As a result, as illustrated in FIG. 13, the second spigot joint flange 16b is fitted to the second spigot joint hole 16a at the second spigot joint fitting portion 16 before the first spigot joint flange 13b is fitted to the first spigot joint hole 13a at the first spigot joint fitting portion 13. Because the second spigot joint flange 16b is attached to the transmission, which is a heavy component, and is positioned at an inner side of the transmission housing 12, visually recognizing the second spigot joint flange 16b during the fitting operation involves difficulties and thus fitting the second spigot joint flange 16b to the second spigot joint hole 16a involves difficulties. In consequence, the second spigot joint flange 16b collides with the crankshaft portion 14 during the fitting, and accordingly a bend and/or deformation occurs easily at the second spigot joint fitting portion 16. The bend and/or deformation cause vibrations of the rotary portion of the transmission 15, for example.

A need thus exists for a joining structure of a power source and a transmission which is not susceptible to the drawback mentioned above.

### SUMMARY

According to an aspect of this disclosure, a joining structure of a power source and a transmission includes a joining portion joining a power source and a transmission to each other coaxially with a rotational axis line in a state where a rotary force corresponding to output from the power source is transmittable to the transmission, the joining portion includes a first fitting portion centering a first housing of the power source and a second housing of the transmission with each other on the rotational axis line, a second fitting portion at which a rotary portion of the transmission is fitted to an output shaft portion of the power source in an axial direction, the second fitting portion centering the rotary portion and the output shaft portion with each other on the rotational axis line, a housing spacer fixed to the first housing to be coaxial with the rotational axis line in such a manner that a first flange is fitted into a first hole provided at the first housing, and a third fitting portion including a protruding portion provided at one of the second housing and the housing spacer and a recessed portion provided at the other of the second housing and the housing spacer, the recessed portion being fitted to the protruding portion in a direction of the rotational axis line and centering the second housing and the housing spacer with each other on the rotational axis line, wherein in a case where the transmission is positioned at a position at which the protruding portion of the third fitting portion and the recessed portion of the third fitting portion start fitting to each other, the rotary portion of the transmission is away from a position at which the rotary portion starts fitting to the output shaft portion of the power source by a predetermined distance.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a longitudinal sectional view illustrating a state in which a third spigot joint fitting portion starts fitting according to a joining structure of a power source and a transmission of a first embodiment disclosed here;

FIG. 2 is a longitudinal sectional view illustrating a joined state of the joining structure illustrated in FIG. 1;

FIG. 3 is a plan view of a dowel pin of the third spigot joint fitting portion of the joining structure illustrated in FIG. 1;

FIG. 4 is a right-side view of FIG. 3;

FIG. 5 is a longitudinal sectional view illustrating a state in which the third spigot joint fitting portion starts the fitting according to a joining structure of a power source and a transmission of a second embodiment disclosed here;

FIG. 6 is a longitudinal sectional view illustrating a joined state of the joining structure illustrated in FIG. 5;

FIG. 7 is a longitudinal sectional view illustrating a state in which the third spigot joint fitting portion starts the fitting according to a joining structure of a power source and a transmission of a third embodiment disclosed here;

FIG. 8 is a longitudinal sectional view illustrating a joined state of the joining structure illustrated in FIG. 7;

FIG. 9 is a longitudinal sectional view illustrating a state in which the third spigot joint fitting portion starts the fitting according to a joining structure of a power source and a transmission of a fourth embodiment disclosed here;

FIG. 10 is a longitudinal sectional view illustrating a joined state of the joining structure illustrated in FIG. 9;

FIG. 11 is a longitudinal sectional view illustrating a state in which the third spigot joint fitting portion starts the fitting according to a joining structure of a power source and a transmission of a fifth embodiment disclosed here;

FIG. 12 is a partial plan view illustrating a first adapter of the joining structure illustrated in FIG. 11;

FIG. 13 is a longitudinal sectional view illustrating a state in which fitting is started according to a joining structure of a power source and a transmission of known art; and

FIG. 14 is a longitudinal sectional view illustrating a joined state of the known joining structure illustrated in FIG. 13.

### DETAILED DESCRIPTION

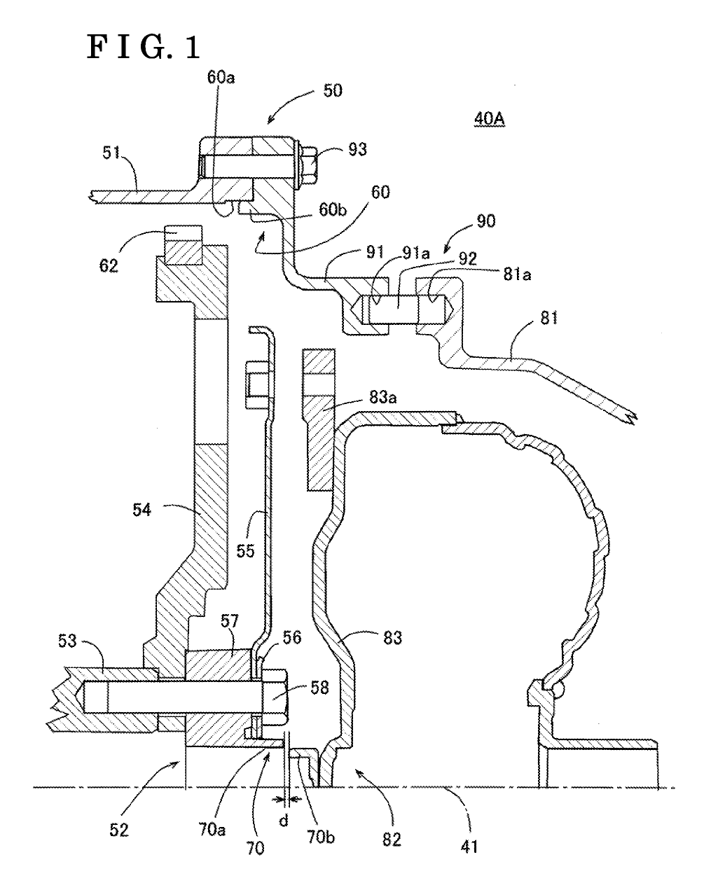

A joining structure 40A of a power source and a transmission according to a first embodiment disclosed here will be explained with reference to FIGS. 1 to 4. The joining structure 40A includes an engine serving as a power source, a transmission with a torque converter serving as a transmission, and an joining portion 50 which joins the engine and the transmission with the torque converter to each other in such a manner that the engine and the transmission with the torque converter are coaxial with a rotational axis line 41, in a state where a rotary force serving as output from the engine can be transmitted to the transmission with the torque converter. At the joining portion 50, an output shaft portion 52 of the engine is provided at an inside of an engine housing 51 (i.e., a first housing) and the output shaft portion 52 includes a crankshaft 53 serving as an output shaft. The transmission with the torque converter serves as the transmission, a rotary portion 82 of the transmission with the torque converter is provided at an inside of a transmission housing 81 (i.e., a second housing), and the rotary portion 82 includes a front cover 83 of the torque converter.

The joining portion 50 includes a first spigot joint fitting portion 60 (i.e., a first fitting portion) which centers the engine housing 51 and the transmission housing 81 with respect to each other on the rotational axis line 41, that is, the engine housing 51 and the transmission housing 81 are arranged in such a manner that a center of the engine housing 51 and a center of the transmission housing 81 are coaxial with the rotational axis line 41. The joining portion 50 includes a second spigot joint fitting portion 70 (i.e., a second fitting portion) at which the rotary portion 82 is fitted to the output shaft portion 52 in an axial direction and which centers the rotary portion 82 and the output shaft portion 52 with respect to each other on the rotational axis line 41.

The first spigot joint fitting portion 60 includes a first spigot joint hole 60a (i.e., a first hole) provided at the engine housing 51 and a first spigot joint flange 60b (i.e., a first flange) fitted to the first spigot joint hole 60a. The first spigot joint flange 60b is provided at a first end of a housing spacer 91. The housing spacer 91 is fixed to the engine housing 51 with a fastening bolt 93 to be coaxial with the rotational axis line 41. A pin hole 91a is provided at a second end of the housing spacer 91, and a dowel pin 92 is press-fitted in the pin hole 91 a in such a manner that the dowel pin 92 protrudes from the second end of the housing spacer 91 by a predetermined length. A pin hole 81a (i.e., a recessed portion) which is to be fitted to the dowel pin 92 (i.e., a protruding portion) is provided at the transmission housing 81. Each of the pin hole 91a, the dowel pin 92 and the pin hole 81a may be provided at plural positions in a circumferential direction.

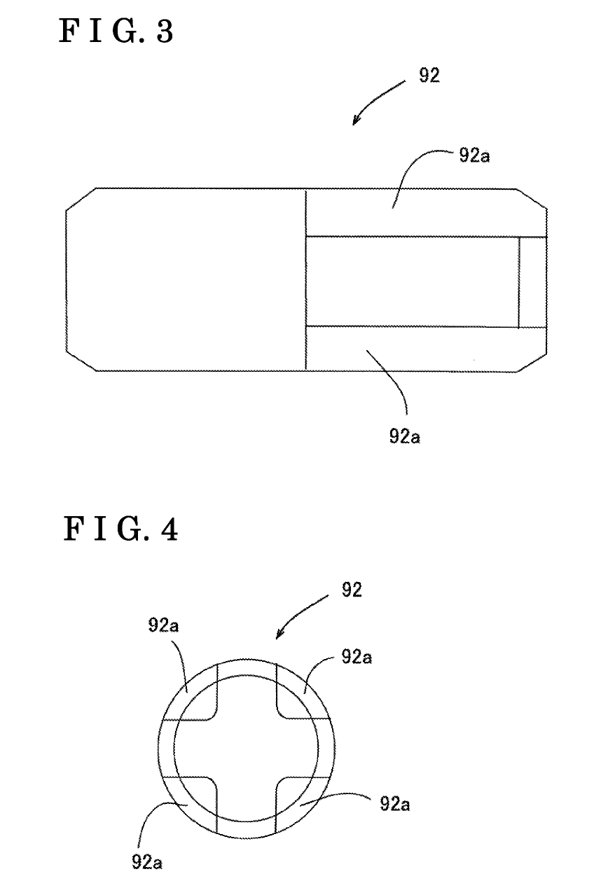

A protruding part of the dowel pin 92, the part protruding from the second end of the housing spacer 91 by the predetermined length, includes a predetermined portion at a distal end side of the protruding part. At the predetermined portion, slits 92a are formed in an axial direction as illustrated in FIGS. 3 and 4. In this embodiment, the slits 92a are formed at four positions, for example. Due to the portions at which the slits 92a are formed, an area of contact of the pin hole 81a and the dowel pin 92 with each other is reduced while the pin hole 81a is being inserted in, that is, fitted around or mated with the dowel pin 92, and thus the insertion of the pin hole 81a to the dowel pin 92 is performed smoothly.

The joining portion 50 is provided with a third spigot joint fitting portion 90 (i.e., a third fitting portion) which causes the pin hole 81a of the transmission housing 81 to fit to the dowel pin 92 of the housing spacer 91 in a direction of the rotational axis line 41, and performs centering of the transmission housing 81 and the housing spacer 91 with each other on the rotational axis line

At the second spigot joint fitting portion 70, a second spigot joint flange 70b provided at the rotary portion 82 of the transmission with the torque converter fits to a second spigot joint hole 70a provided at the output shaft portion 52 of the engine. The second spigot joint flange 70b corresponds to an insertion end of the rotary portion 82. The output shaft portion 52 of the engine includes a structure in which the a flywheel 54, a drive plate 55, a reinforce plate 56 and a shim 57 are fixed to the crankshaft 53 with a fastening bolt 58 in such a manner that the flywheel 54, the drive plate 55, the reinforce plate 56 and the shim 57 are fastened together with one another with the fastening bolt 58. That is, the flywheel 54, the drive plate 55, the reinforce plate 56 and the shim 57 are co-fastened or integrally-fastened with one another with the fastening bolt 58. Specifically, the second spigot joint hole 70a is provided at the shim 57. The rotary portion 82 of the transmission with the torque converter includes the front cover 83 of the torque converter and the second spigot joint flange 70b is provided at the front cover 83.

As illustrated in FIG. 1, when the transmission with the torque converter is positioned at a position at which the pin hole 81a of the third spigot joint fitting portion 90 and the dowel pin 92 of the third spigot joint fitting portion 90 start the fitting to each other, the second spigot joint flange 70b of the second spigot joint fitting portion 70 is away by a predetermined distance d from a position at which the second spigot joint flange 70b starts fitting to the second spigot joint hole 70a, that is, away from the second spigot joint hole 70a. In other words, when the transmission with the torque converter is positioned at the position at which the pin hole 81a and the dowel pin 92 start fitting to each other, the second spigot joint flange 70b of the second spigot joint fitting portion 70 is separated by the predetermined distance d from the position at which the rotary portion 82 of the transmission with the torque converter starts fitting to the output shaft portion 52, that is, separated from the output shaft portion 52. In other words, when the transmission is positioned at the position at which the dowel pin 92 and the pin hole 81a start fitting to each other, the rotary portion 82 of the transmission has not reached the position at which the rotary portion 82 starts fitting to the output shaft portion 52 of the engine, and the predetermined distance d is provided between the rotary portion 82 and the output shaft portion 52.

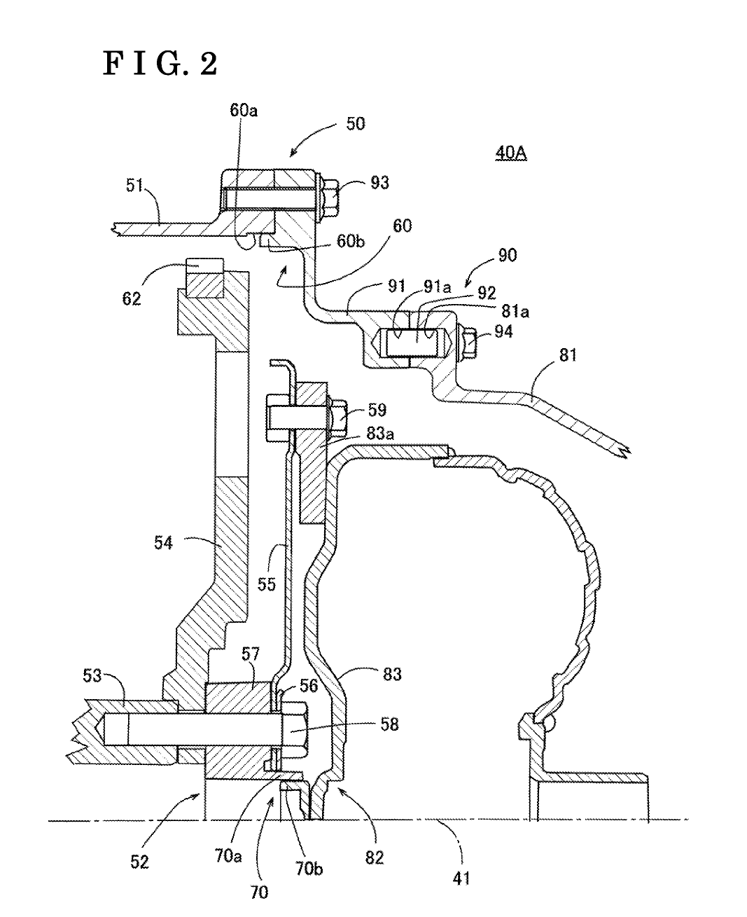

From the above-described state, the pin hole 81a is brought to be fitted to the dowel pin 92 as illustrated in FIG. 2. Due to the fitting of the pin hole 81a to the dowel pin 92, positioning of the second spigot joint flange 70b at a side of the rotary portion 82 of the transmission with the torque converter and the second spigot joint hole 70a at a side of the output shaft portion 52 with each other relative to the rotational axis line 41 is conducted at the second spigot joint fitting portion 70. In addition, the fitting of the second spigot joint flange 70b and the second spigot joint hole 70a to each other is guided at the second spigot joint fitting portion 70. Accordingly, the second spigot joint flange 70b and the second spigot joint hole 70a are fitted to each other, and thus the centering is performed by the second spigot joint fitting portion 70. Because the position of the rotary portion 82 of the transmission with the torque converter and the position of the output shaft portion 52 of the engine are adjusted relative to the rotational axis line 41 by the third spigot joint fitting portion 90, and then the fitting of the second spigot joint fitting portion 70 is started, the rotary portion 82 of the transmission with the torque converter is prevented from colliding with the output shaft portion 52 of the engine. Accordingly, the centering of the rotary portion 82 of the transmission with the torque converter and the output shaft portion 52 of the engine is conducted easily, and it is prevented that a bend and/or deformation is caused at the second spigot joint fitting portion 70 by the collision or contact of the rotary portion 82 of the transmission with the torque converter with the output shaft portion 52 of the engine. By providing the housing spacer 91, the third spigot joint fitting portion 90 can be positioned before the output shaft portion 52 of the engine in a direction in which the fitting proceeds, and therefore a configuration is obtained in which the rotary portion 82 of the transmission with the torque converter does not collide with the output shaft portion 52 of the engine before the fitting of the second spigot joint fitting portion 70 starts.

As illustrated in FIG. 2, after the fitting of the second spigot joint fitting portion 70 is conducted, an attachment flange 83a fixed to the drive plate 55 and to the front cover 83 is fastened with a fastening bolt 59, and thus the output shaft portion 52 and the rotary portion 82 of the transmission with the torque converter are joined to each other. The housing spacer 91 and the transmission housing 81 are fixed to each other with a fastening bolt 94, thereby joining the engine housing 51 and the transmission housing 81 to each other. When the torque converter rotates, the front cover 83 is expanded by a centrifugal force or pressure of torque converter fluid. The drive plate 55 may absorb a thrust force in the axial direction which is attributed to the expansion, that is, ballooning, of the torque converter. A gear 62 for an engine starter is provided at an outer circumference of the flywheel 54.

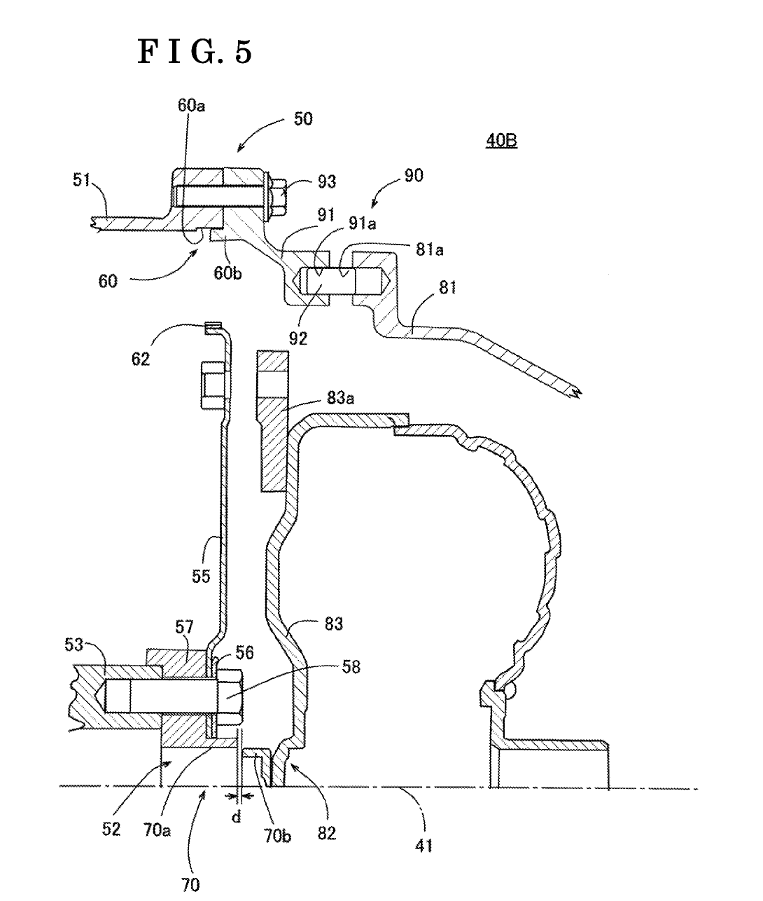

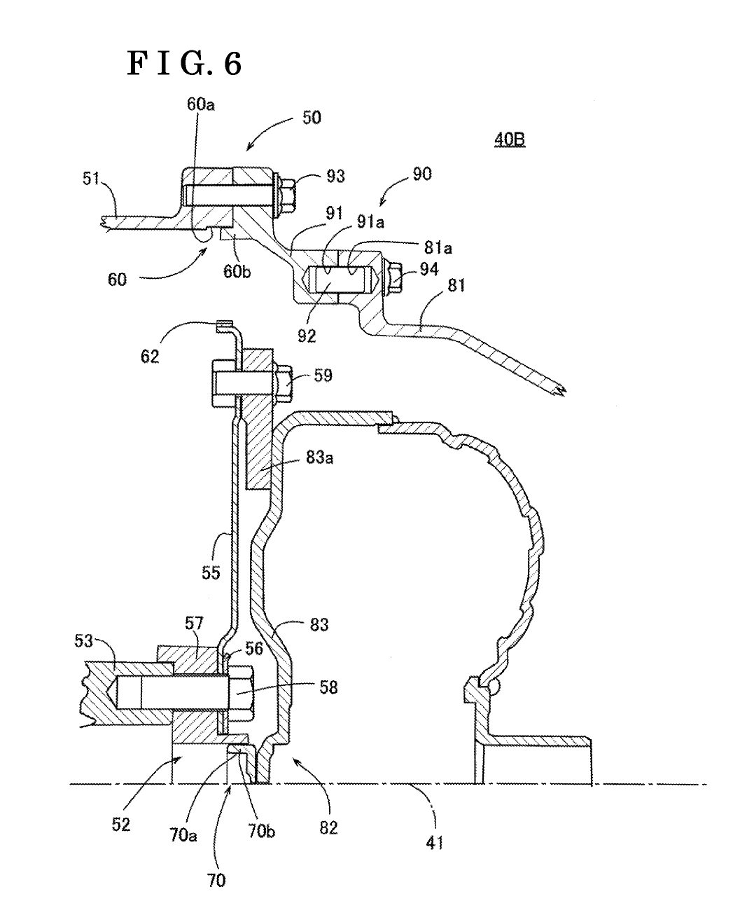

A joining structure 40B of a power source and a transmission according to a second embodiment disclosed here will be explained with reference to FIGS. 5 and 6. The joining structure 40B of the power source and the transmission of the second embodiment is different from the joining structure 40A of the power source and the transmission of the first embodiment in that the joining structure 40B does not include the flywheel 54 and that the gear 62 for the engine starter is provided at an outer circumference of the drive plate 55. The structures of the joining portion 50, the first spigot joint fitting portion 60, the second spigot joint fitting portion 70, the third spigot joint fitting portion 90 according to the joining structure 40B are similar to the joining structure 40A. A state in which the third spigot joint fitting portion 90 of the joining structure 40B starts fitting is illustrated in FIG. 5. A joined state of the joining structure 40B is illustrated in FIG. 6. The operations of the joining portion 50, the first spigot joint fitting portion 60, the second spigot joint fitting portion 70, the third spigot joint fitting portion 90 at the joining structure 40B are same as the operations of the joining portion 50, the first spigot joint fitting portion 60, the second spigot joint fitting portion 70, the third spigot joint fitting portion 90 at the joining structure 40A of the first embodiment, and therefore detailed explanations will be omitted.

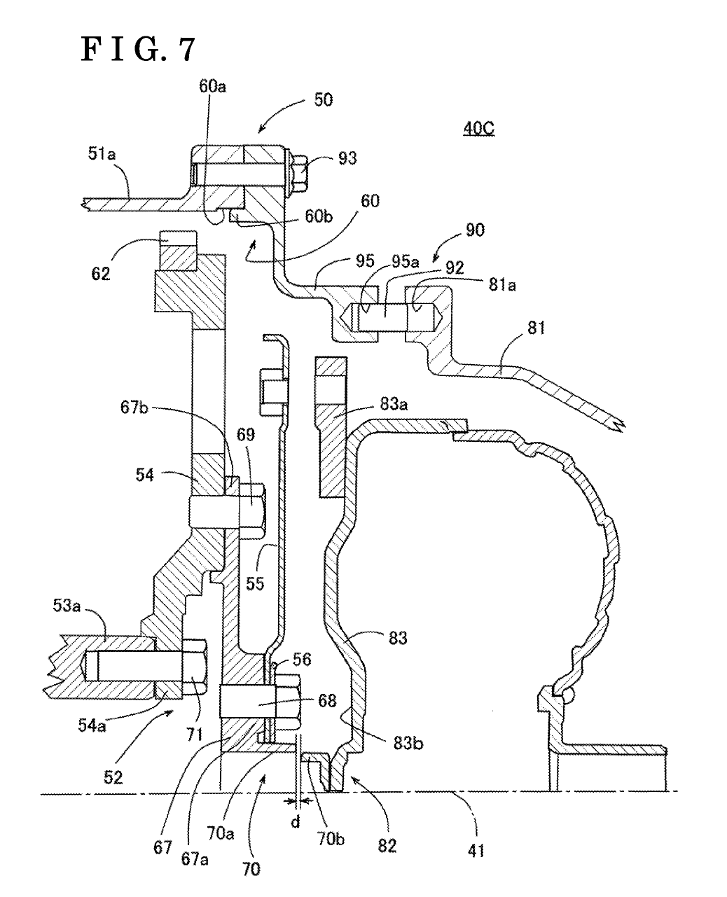

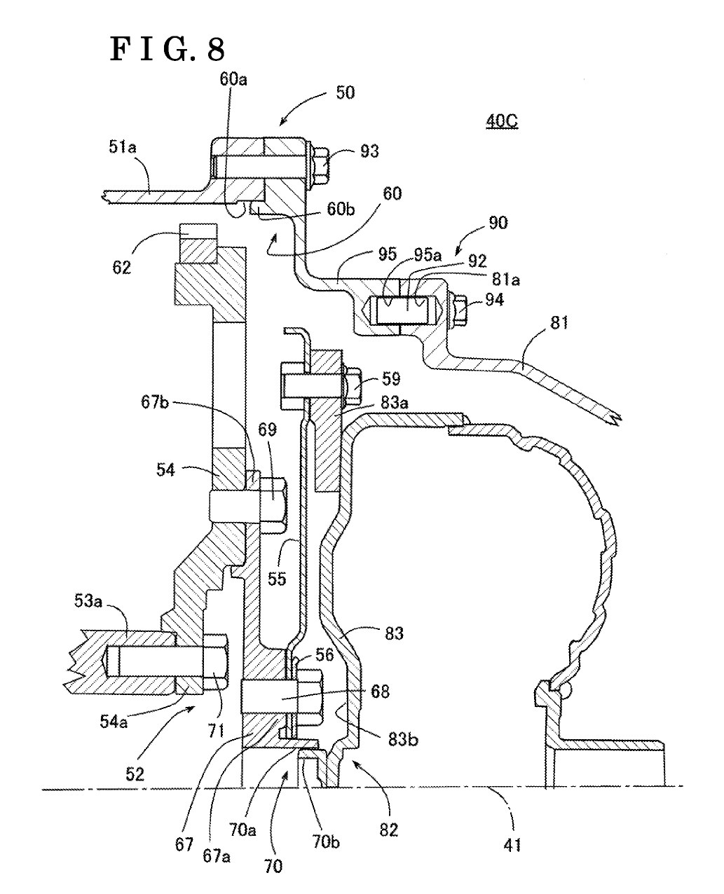

Next, a joining structure 40C of a power source and a transmission according to a third embodiment disclosed here will be explained with reference to FIGS. 7 and 8. According to the joining structure 40C of the power source and the transmission of the third embodiment, for example, the transmission with the torque converter (i.e., the transmission) including the specifications same as the transmission with the torque converter of the joining structure 40A of the first embodiment may be joined to plural types or models of the engines (i.e., the power source), that is, may be applicable to plural engine types or engine models.

As illustrated in FIG. 7, in the joining structure 40C of the power source and the transmission of the third embodiment, the housing spacer 91 of the joining structure 40A of the first embodiment corresponds to a first adapter 95 provided for each type of the engines. The first adapter 95 allows the first spigot joint fitting portion 60 to be adapted to an engine housing 51a (i.e., the first housing) that is different from the engine housing 51 so that the first spigot joint fitting portion 60 is provided at the engine housing 51a. The shim 57 of the joining structure 40A of the first embodiment corresponds to a second adapter 67 provided for each type of the engine. The second adapter 67 is fixed to a crankshaft 53a (i.e., the output shaft) that is different from the crankshaft 53 to form the output shaft portion 52.

At the first spigot joint fitting portion 60, the first spigot joint flange 60b fitted to the first spigot joint hole 60a provided at the engine housing 51a is provided at a first end of the first adapter 95. The first adapter 95 is fixed to the engine housing 51a with the fastening bolt 93. A pin hole 95a is provided at a second end of the first adapter 95, and the dowel pin 92 is press-fitted in the pin hole 95a in such a manner that the dowel pin 92 protrudes from the second end of the first adapter 95 by the predetermined length. The pin hole 81a which fits to the dowel pin 92 is provided at the transmission housing 81.

At the second spigot joint fitting portion 70, the second spigot joint hole 70a is provided at the second adapter 67 in a manner that the second spigot joint hole 70a is adapted to the second spigot joint flange 70b provided at the front cover 83 of the torque converter so that the second spigot joint flange 70b is inserted in the second spigot joint hole 70a and is fitted thereto.

As illustrated in FIGS. 7 and 8, the second adapter 67 of the joining structure 40C of the third embodiment includes a fixing portion 67a (i.e., a first fixing portion) and a fixing portion 67b (i.e., a second fixing portion). The drive plate 55 and the reinforce plate 56 are fixed to the fixing portion 67a with a fastening bolt 68. The flywheel 54 is fixed to the fixing portion 67b with a fastening bolt 69. The flywheel 54 of the joining structure 40C of the third embodiment is provided with a fixing portion 54a (i.e., a third fixing portion) fixed to the crankshaft 53a with a fastening bolt 71. The fixing portions 67a, 67b and 54a are provided at positions which are different from one another in a radial direction of the transmission. As described above, at the output shaft portion 52 of the third embodiment, the crankshaft 53a, the flywheel 54, the second adapter 67, the drive plate 55 and the reinforce plate 56 are fixed with the three fastening bolts 68, 69 and 71 at the respective three fixing portions 67a, 67b and 54a. Consequently, compared to the co-fastening or integral-fastening using the single bolt, tightening torque of each of the fastening bolts can be reduced and the assembling is easier. In addition, the structure is advantageous or effective to prevent each of the fastening bolts from loosening. Further, the positions of the crankshaft 53a, the flywheel 54, the second adapter 67, the drive plate 55 and the reinforce plate 56 are adjusted with one another easily while the crankshaft 53a, the flywheel 54, the second adapter 67, the drive plate 55 and the reinforce plate 56 are being fastened with the fastening bolts 68, 69 and 71.

As described above, the fixing portions 67a, 67b and 54a are arranged at the positions which are different in the radial direction from one another, thereby enhancing a degree of freedom in arrangement. As a result, the fixing portions 67a fixing the drive plate 55 and being arranged at the closest position to the front cover 83 of the torque converter can be provided to face a concave portion 83b of the front cover 83 of the torque converter. Accordingly, even in a case where the front cover 83 is expanded by the centrifugal force or pressure of the torque converter fluid while the torque converter is rotating, a clearance is assured between the fastening bolt 68 of the fixing portion 67a and the concave portion 83b. In consequence, the fastening bolt 68 can be arranged to be close to the front cover 83, and thus a size of the joining structure in the axial direction is reduced.

A state in which the third spigot joint fitting portion 90 of the joining structure 40C of the third embodiment starts fitting is illustrated in FIG. 7. A joined state at the joining structure 40C is illustrated in FIG. 8. The operations of the joining portion 50, the first spigot joint fitting portion 60, the second spigot joint fitting portion 70, the third spigot joint fitting portion 90 at the joining structure 40C are same as the operations of the joining portion 50, the first spigot joint fitting portion 60, the second spigot joint fitting portion 70, the third spigot joint fitting portion 90 at the joining structure 40A of the first embodiment, and therefore detailed explanations will be omitted. Thus, the transmission with the torque converter can be joined to the plural types of the engines via the first adapter 95 and the second adapter 67. There is no need to change or modify the transmission with the torque converter (i.e., the transmission) itself and/or the plural types of engines (i.e., the power sources) themselves to join the transmission with the torque converter to the plural engine types.

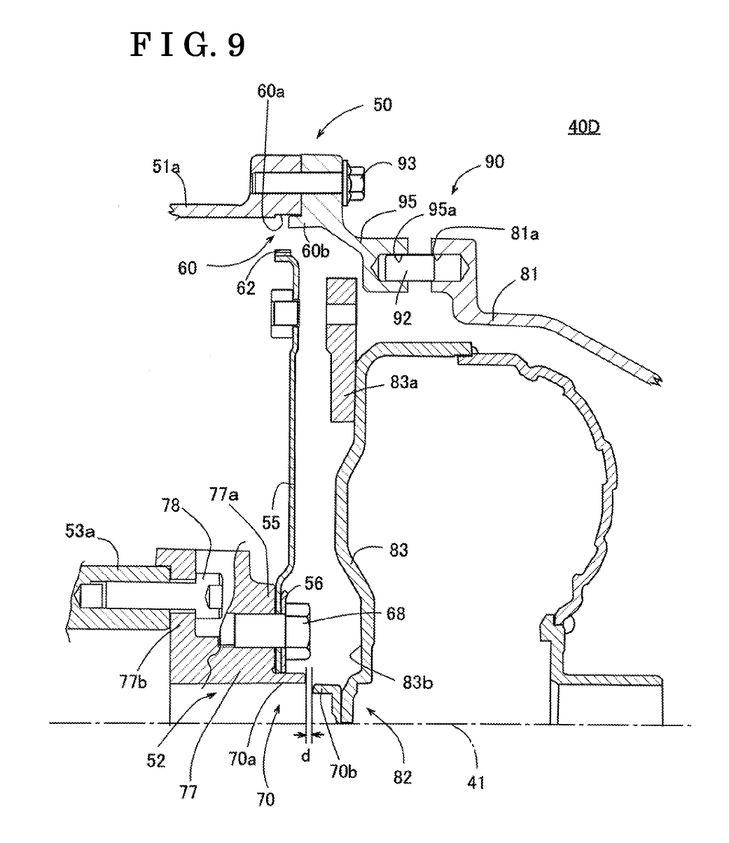

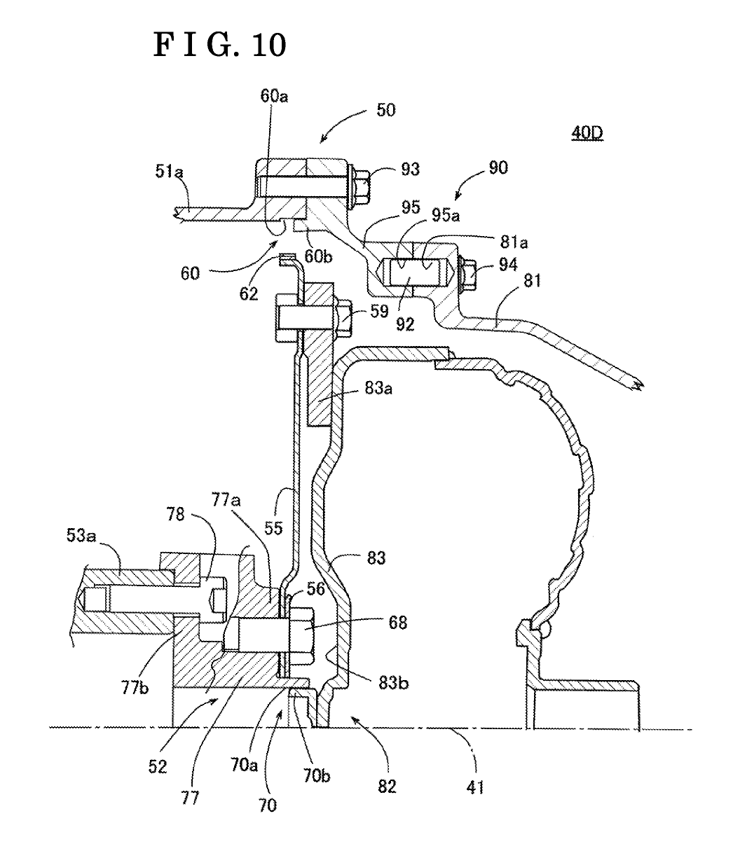

Next, a joining structure 40D of a power source and a transmission according to a fourth embodiment disclosed here will be explained with reference to FIGS. 9 and 10. According to the joining structure 40D of the power source and the transmission of the fourth embodiment, for example, the transmission with the torque converter (i.e., the transmission) including the specifications same as the transmission with the torque converter of the joining structure 40B of the second embodiment may be joined to plural types or models of engines (i.e., the power sources), that is, may be applicable to plural engine types or engine models.

As illustrated in FIG. 9, according to the joining structure 40D of the power source and the transmission of the fourth embodiment, the housing spacer 91 of the joining structure 4B of the second embodiment corresponds to the first adapter 95 provided for each type of the engines. The first adapter 95 allows the first spigot joint fitting portion 60 to be adapted to the engine housing 51a that is different from the engine housing 51 so that the first spigot joint fitting portion 60 is provided at the engine housing 51a. The shim 57 of the joining structure 40B of the second embodiment corresponds to a second adapter 77 provided for each of the types of the engines. The second adapter 77 is fixed to the crankshaft 53a that is different from the crankshaft 53 to form the output shaft portion 52.

At the first spigot joint fitting portion 60, the first spigot joint flange 60b fitted to the first spigot joint hole 60a provided at the engine housing 51a is provided at the first end of the first adapter 95. The first adapter 95 is fixed to the engine housing 51a with the fastening bolt 93. The pin hole 95a is provided at the second end of the first adapter 95, and the dowel pin 92 is press-fitted in the pin hole 95a in such a manner that the dowel pin 92 protrudes from the second end of the first adapter 95 by the predetermined length. The pin hole 81a which fits to the dowel pin 92 is provided at the transmission housing 81.

At the second spigot joint fitting portion 70, the second spigot joint hole 70a is provided at the second adapter 77 in a manner that the second spigot joint hole 70a is adapted to the second spigot joint flange 70b provided at the front cover 83 of the torque converter so that the second spigot joint flange 70b is inserted in the second spigot joint hole 70a and is fitted thereto.

As illustrated in FIGS. 9 and 10, the second adapter 77 of the joining structure 40D of the fourth embodiment includes a fixing portion 77a (i.e., the first fixing portion) and a fixing portion 77b (i.e., the second fixing portion). The drive plate 55 and the reinforce plate 56 are fixed to the fixing portion 77a with the fastening bolt 68. The fixing portion 77b is fixed to the crank shaft 53a with a fastening bolt 78. The fixing portions 77a and 77b are provided at positions which are different from each other in the radial direction of the transmission. As described above, according to the output shaft portion 52 of the fourth embodiment, at the two fixing portions 77a and 77b, the crankshaft 53a, the second adapter 77, the drive plate 55 and the reinforce plate 56 are fixed with the two fastening bolts 68 and 78. Consequently, compared to the co-fastening or integral-fastening using the single bolt, the tightening torque of each of the fastening bolts can be reduced and the assembling becomes easier. In addition, the structure is advantageous or effective to prevent each of the fastening bolts from loosening. The positions of the crankshaft 53a, the second adapter 77, the drive plate 55 and the reinforce plate 56 are adjusted with one another easily while the crankshaft 53a, the second adapter 77, the drive plate 55 and the reinforce plate 56 are being fastened with the bolts 68 and 78.

As described above, the fixing portions 77a and 77b are arranged at the positions which are different in the radial direction from each other, thereby enhancing the degree of freedom in the arrangement. As a result, the fixing portions 77a fixing the drive plate 55 and being arranged at the closest position to the front cover 83 of the torque converter can be provided to face the concave portion 83b of the front cover 83 of the torque converter. Accordingly, even in a case where the front cover 83 is expanded by the centrifugal force or pressure of the torque converter fluid while the torque converter is rotating, the clearance is assured between the fastening bolt 68 of the fixing portion 77a and the concave portion 83b. In consequence, the fastening bolt 68 can be arranged to be close to the front cover 83, and thus the size of the joining structure in the axial direction is reduced.

A state in which the third spigot joint fitting portion 90 of the joining structure 40D of the fourth embodiment starts fitting is illustrated in FIG. 9. A joined state at the joining structure 40D is illustrated in FIG. 10. The operations of the joining portion 50, the first spigot joint fitting portion 60, the second spigot joint fitting portion 70, the third spigot joint fitting portion 90 at the joining structure 40D are same as the operations of the joining portion 50, the first spigot joint fitting portion 60, the second spigot joint fitting portion 70, the third spigot joint fitting portion 90 at the joining structure 40B of the second embodiment, and therefore detailed explanations will be omitted. Thus, the transmission with the torque converter can be joined to the plural types of the engines via the first adapter 95 and the second adapter 77. There is no need to change or modify the transmission with the torque converter (i.e., the transmission) itself and/or the plural types of engines (i.e., the power sources) themselves to join the transmission with the torque converter to the plural engine types.

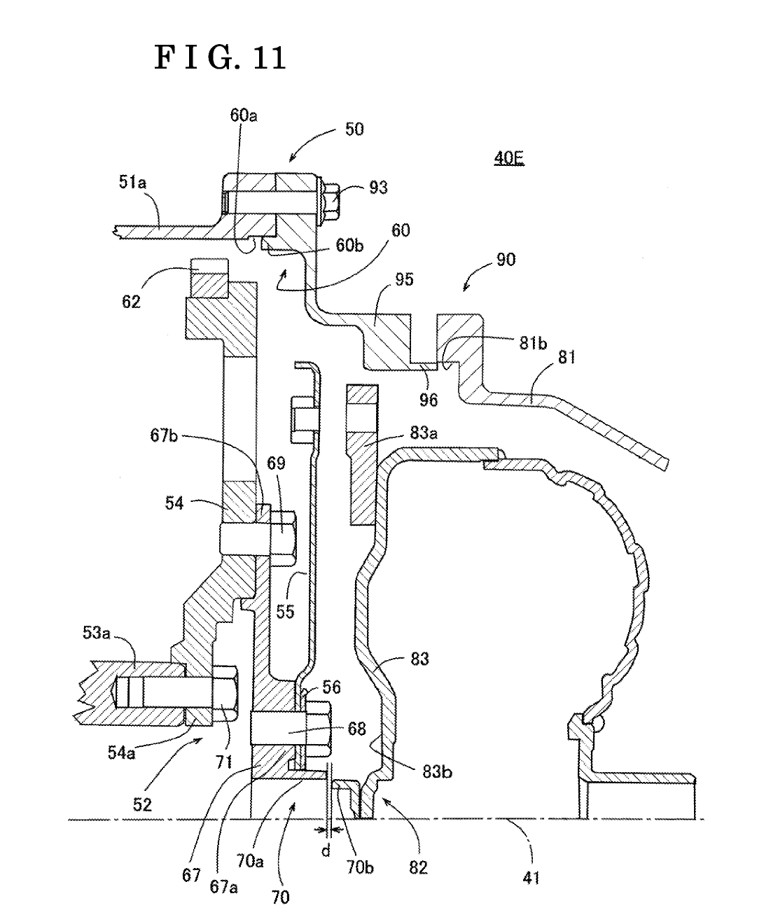

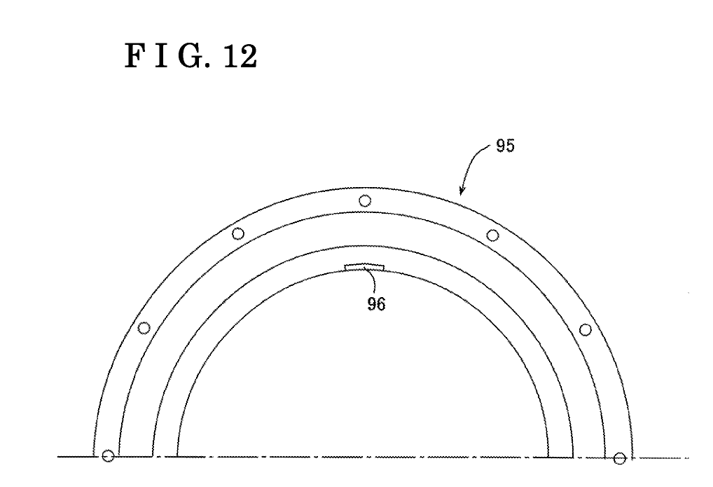

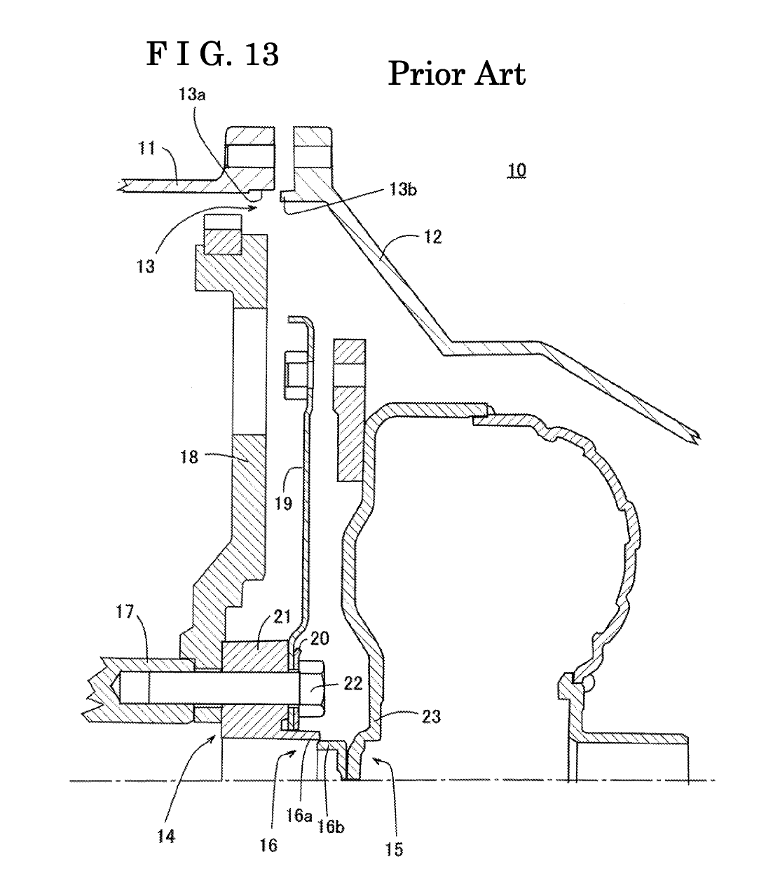

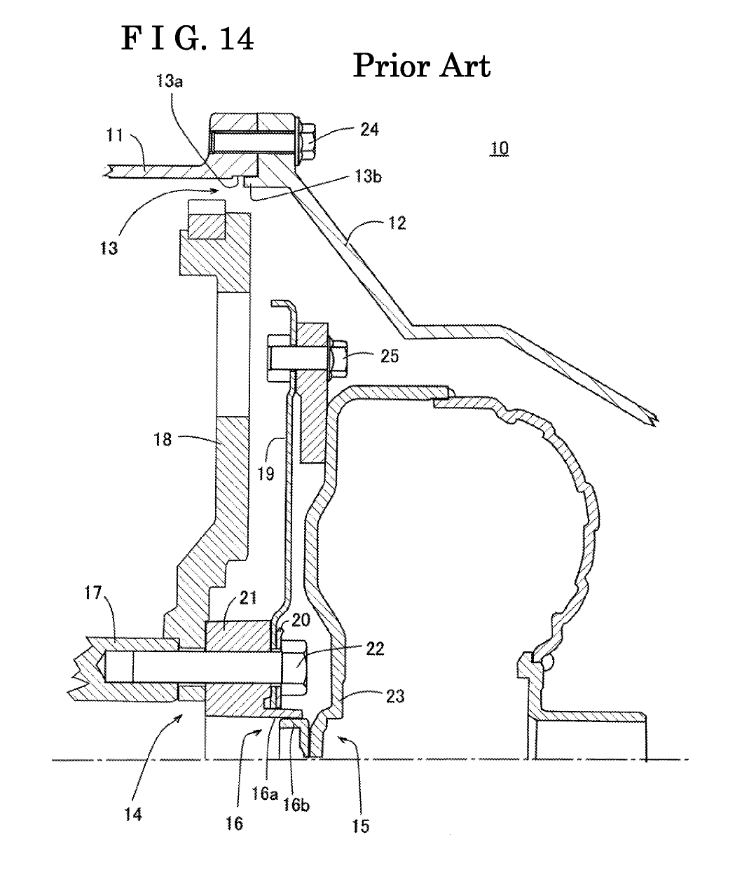

Next, a joining structure 40E of a power source and a transmission according to a fifth embodiment disclosed here will be explained with reference to FIGS. 11 and 12. The joining structure 40E of the power source and the transmission of the fifth embodiment includes a structure which differs from the joining structure 40C of the power source and the transmission of the aforementioned third embodiment in that a partial spigot joint flange 96 is provided at the first adapter 95 instead of the dowel pin 92 of the third spigot joint fitting portion 90.

At the first spigot joint fitting portion 60, the first spigot joint flange 60b fitted to the first spigot joint hole 60a provided at the engine housing 51a is provided at the first end of the first adapter 95. The first adapter 95 is fixed to the engine housing 51a with the fastening bolt 93. As illustrated in FIGS. 11 and 12, the partial spigot joint flange 96 (i.e., the protruding portion) is provided at the second end of the first adapter 95 at two positions which are symmetrical to each other in a circumferential direction of the adapter 95 in such a manner that each of the partial spigot joint flanges 96 protrudes from the second end of the first adapter 95 by the predetermined length. A spigot joint hole 81b (i.e., the recessed portion) which fits to the partial spigot joint flanges 96 is provided at the transmission housing 81. In this embodiment, the partial spigot joint flanges 96 are provided at the two positions, however, the number of the partial spigot joint flanges 96 is not limited to two.

The joining portion 50 is provided with the third spigot joint fitting portion 90 which causes the spigot joint hole 81b of the transmission housing 81 to fit to the partial spigot joint flanges 96 of the first adapter 95 in the direction of the rotational axis line 41, and centers the transmission housing 81 and the first adapter 95 with respect to each other on the rotational axis line 41. Due to the partial spigot joint flanges 96, the area of contact of the spigot joint hole 81b and the partial spigot joint flanges 96 with each other while the partial spigot joint flanges 96 are being inserted in the spigot joint hole 81b is reduced, and thus the insertion, that is, the fitting, of the spigot joint hole 81b to the partial spigot joint flanges 96 is performed more smoothly compared to a case where the spigot joint flanges are formed along the entire circumference of the first adapter 95.

A state in which the third spigot joint fitting portion 90 of the joining structure 40E of the fifth embodiment starts fitting is illustrated in FIG. 11. The operations of the joining portion 50, the first spigot joint fitting portion 60, the second spigot joint fitting portion 70, the third spigot joint fitting portion 90 at the joining structure 40E are same as the operations of the joining portion 50, the first spigot joint fitting portion 60, the second spigot joint fitting portion 70, the third spigot joint fitting portion 90 at the joining structure 40C of the third embodiment, and therefore detailed explanations will be omitted. Thus, the transmission with the torque converter can be joined to a different type or model of the engine via the first adapter 95 and the second adapter 67. There is no need to change or modify the transmission with the torque converter (i.e., the transmission) itself and/or the different type of the engine (i.e., the power source) itself to join the transmission with the torque converter to the different type of the engine.

In the aforementioned embodiments, the explanations are made on a case where the power source is the engine, however, the power source is not limited thereto. The power source may be an electric motor instead of the engine. A combination of the engine and the electric motor may be used as the power source.

In the aforementioned embodiments, the explanations are made on a case where the transmission is the torque converter type transmission, however, the transmission is not limited thereto. The transmission may be a dual clutch transmission instead of the torque converter type transmission.

In the aforementioned embodiments, the example is shown in which the second spigot joint hole 70a of the second spigot joint fitting portion 70 is provided at the output shaft portion 52 of the engine and the second spigot joint flange 70b that is to be fitted to the second spigot joint hole 70a is provided at the rotary portion 82 of the transmission with the torque converter. However, the second spigot joint hole 70a of the second spigot joint fitting portion 70 may be provided at the rotary portion 82 of the transmission with the torque converter and the second spigot joint flange 70b that is to be fitted to the second spigot joint hole 70a may be provided at the output shaft portion 52 of the engine.

In the aforementioned embodiments, the explanations are made to a case where the dowel pin 92 of the third spigot joint fitting portion 90 is provided at the housing spacer 91, 95 and the pin hole 81a to which the dowel pin 92 is fitted is provided at the transmission housing 81. However, alternatively, the dowel pin 92 of the third spigot joint fitting portion 90 may be provided at the transmission housing 81 and the pin hole 81a fitted to the dowel pin 92 is provided at the housing spacer 91, 95.

In the aforementioned embodiments, the partial spigot joint flanges 96 of the third spigot joint fitting portion 90 are provided at the first adapter 95 and the spigot joint hole 81b that is to be fitted to the partial spigot joint flanges 96 is provided at the transmission housing 81. However, alternatively, the partial spigot joint flanges 96 of the third spigot joint fitting portion 90 may be provided at the transmission housing 81 and the spigot joint hole 81b that is to be fitted to the partial spigot joint flanges 96 may be provided at the first adapter 95 or the housing spacer 91.

As described above, the joining structure 40A, 40B, 40C, 40D, 40E of the power source and the transmission of the first to fifth embodiments disclosed here includes the joining portion 50 joining the engine and the transmission with the torque converter to each other coaxially with the rotational axis line 41 in a state where the rotary force corresponding to the output from the engine is transmittable to the transmission with the torque converter. The joining portion 50 includes the first spigot joint fitting portion 60 centering the engine housing 51, 51a of the engine and the transmission housing 81 of the transmission with the torque converter with each other on the rotational axis line 41, the second spigot joint fitting portion 70 at which the rotary portion 82 of the transmission with the torque converter is fitted to the output shaft portion 52 of the engine in the axial direction, the second spigot joint fitting portion 70 centering the rotary portion 82 and the output shaft portion 52 with each other on the rotational axis line 41, the housing spacer 91, 95 fixed to the engine housing 51, 51a to be coaxial with the rotational axis line 41 in such a manner that the first spigot joint flange 60b is fitted into the first spigot joint hole 60a provided at the engine housing 51, 51a, and the third spigot joint fitting portion 90 including the dowel pin 92 or the partial spigot joint flange 96 which is provided at one of the transmission housing 81 and the housing spacer 91, 95 and the pin hole 81a or the spigot joint hole 81b provided at the other of the transmission housing 81 and the housing spacer 91, 95, the pin hole 81a or the spigot joint hole 81b being fitted to the dowel pin 92 or the partial spigot joint flange 96 in the direction of the rotational axis line 41 and centering the transmission housing 81 and the housing spacer 91, 95 with each other on the rotational axis line 41, wherein in a case where the transmission with the torque converter is positioned at the position at which the dowel pin 92 or the partial spigot joint flange 96 of the third spigot joint fitting portion 90 and the pin hole 81a or the spigot joint hole 81b of the third spigot joint fitting portion 90 start fitting to each other, the rotary portion 82 of the transmission with the torque converter is away from the position at which the rotary portion 82 starts fitting to the output shaft portion 52 of the engine by the predetermined distance d. Because the position of the rotary portion 82 of the transmission with the torque converter and the position of the output shaft portion 52 of the engine are adjusted relative to the rotational axis line 41 by the third spigot joint fitting portion 90, and then the fitting of the second spigot joint fitting portion 70 is started, the rotary portion 82 of the transmission with the torque converter is prevented from colliding with the output shaft portion 52 of the engine. Accordingly, the centering of the rotary portion 82 of the transmission with the torque converter and the output shaft portion 52 of the engine is conducted easily, and the bend and/or deformation is prevented from occurring at the second spigot joint fitting portion 70 due to the collision or contact of the rotary portion 82 of the transmission with the torque converter with the output shaft portion 52 of the engine. By providing the housing spacer 91, 95, the third spigot joint fitting portion 90 can be positioned before the output shaft portion 52 of the engine in the direction in which the fitting operation progresses, and therefore the rotary portion 82 of the transmission with the torque converter is prevented from colliding with the output shaft portion 52 of the engine prior to the fitting of the second spigot joint fitting portion 70 is started.

As described above, according to the aforementioned embodiments, because the position of the rotary portion 82 of the transmission with the torque converter and the position of the output shaft portion 52 of the engine are adjusted relative to the rotational axis line 41 by the third spigot joint fitting portion 90, and then the fitting of the second spigot joint fitting portion 70 is started, the rotary portion 82 of the transmission with the torque converter is prevented from colliding with the output shaft portion 52 of the engine. Accordingly, the centering of the rotary portion 82 of the transmission with the torque converter and the output shaft portion 52 of the engine is conducted easily, and the bend and/or deformation is prevented from occurring at the second spigot joint fitting portion 70 due to the collision or contact of the rotary portion 82 of the transmission with the torque converter with the output shaft portion 52 of the engine. By providing the housing spacer 91, 95, the third spigot joint fitting portion 90 can be positioned before the output shaft portion 52 of the engine in the direction in which the fitting progresses, and therefore the rotary portion 82 of the transmission with the torque converter is prevented from colliding with the output shaft portion 52 of the engine prior to the fitting of the second spigot joint fitting portion 70 is started.

As described above, according to the joining structure 40A, 40B, 40C, 40D of the power source and the transmission of the first to forth embodiments disclosed here, the protruding portion of the third spigot joint fitting portion 90 corresponds to the dowel pin 92 and the recessed portion of the third spigot joint fitting portion 90 corresponds to the pin hole 81a fitted to the dowel pin 92. According to the above-described configuration, the centering of the transmission housing 81 and the housing spacer 91 with each other on the rotational axis line 41 is conducted with the simple configuration including the pin and the pin hole.

As described above, according to the joining structure 40C, 40D, 40E of the power source and the transmission of the third to fifth embodiments disclosed here, the joining structure 40C, 40D, 40E allows the transmission with the torque converter to be joined to plural types of engines and the housing spacer 95 corresponds to the first adapter 95 provided for each of the types of the engines. The joining structure 40C, 40D, 40E further includes the second adapter 67, 77 fixed to the crankshaft 53a of the engine and provided with the output shaft portion 52, the second adapter 67, 77 being provided for each of the types of the engines. According to the above-described configuration, the transmission with the torque converter can be joined to the plural types of the engines via the first adapter 95 and the second adapter 67, 77. There is no need to change or modify the transmission with the torque converter itself and/or the plural types of engines themselves to allow the transmission with the torque converter to be fitted to the plural engine types.

As described above, according to the joining structure 40D of the power source and the transmission of the forth embodiment disclosed here, the second adapter 77 includes the fixing portion 77a fixing the drive plate 55 fastened to the rotary portion 82 of the transmission with the torque converter and the fixing portion 77b fixed to the crankshaft 53a of the output shaft portion 52, and the fixing portions 77a and 77b are provided at the positions which are different from each other in the radial direction of the transmission with the torque converter. According to the above-described configuration, the second adapter 77, the drive plate 55 and the crankshaft 53a are fixed at the two fixing portion 77a and 77b, and therefore the fastening bolts are prevented from loosening more effectively compared to the co-fastening or integral-fastening at one fixing portion.

As described above, according to the joining structure 40C, 40E of the power source and the transmission of the third and fifth embodiments disclosed here, the second adapter 67 includes the fixing portion 67a fixing the drive plate 55 fastened to the rotary portion 82 of the transmission with the torque converter and the fixing portion 67b fixing the flywheel 54, the flywheel 54 and the crankshaft 53a of the output shaft portion 52 are fixed to each other at the fixing portion 54a, and the fixing portions 67a, 67b and 54a are provided at the positions which are different from one another in the radial direction of the transmission with the torque converter. According to the above-described configuration, the crankshaft 53a, the flywheel 54, the second adapter 67, the drive plate 55 and the reinforce plate 56 are fixed at the three fixing portion 67a, 67b and 54a, and therefore the fastening bolts are prevented from loosening more effectively compared to the co-fastening or integral-fastening at one fixing portion.

As described above, according to the joining structure 40C, 40D, 40E of the power source and the transmission of the third to fifth embodiments disclosed here, the rotary portion 82 of the transmission with the torque converter includes the front cover 83 expanding in the axial direction during the rotation and the fixing portion 77a is provided to face the concave portion 83b formed at the front cover 83. According to the above-described configuration, even in a case where the front cover 83 is expanded, the clearance is ensured between the fixing portion 67a, 77a and the concave portion 83b. In consequence, the fixing portion 67a, 77a can be arranged to be close to the front cover 83, and thus the size of the joining structure in the axial direction is reduced.

As described above, the protruding portion of the third fitting portion 90 corresponds to the partial spigot joint flange 96 and the recessed portion of the third spigot joint fitting portion 90 corresponds to the spigot joint hole 81b fitted to the partial spigot joint flange 96, and the partial spigot joint flange 96 is provided at the two positions of the first adapter 95 which are symmetrical to each other in the circumferential direction. According to the above-described configuration, the centering of the transmission housing 81 and the first adapter 95 with each other on the rotational axis line 41 is conducted with the simple configuration including the flange and the hole.

In a case where there exist plural embodiments, the features of each embodiment may be appropriately combined with one another unless otherwise specified.

The principles, preferred embodiments and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A joining structure of a power source and a transmission, comprising:
a joining portion joining a power source and a transmission to each other coaxially with a rotational axis line in a state where a rotary force corresponding to output from the power source is transmittable to the transmission, the joining portion including;
a first fitting portion centering a first housing of the power source and a second housing of the transmission with each other on the rotational axis line;
a second fitting portion at which a rotary portion of the transmission is fitted to an output shaft portion of the power source in an axial direction, the second fitting portion centering the rotary portion and the output shaft portion with each other on the rotational axis line;
a housing spacer fixed to the first housing to be coaxial with the rotational axis line in such a manner that a first flange is fitted into a first hole provided at the first housing; and
a third fitting portion including a protruding portion provided at one of the second housing and the housing spacer and a recessed portion provided at the other of the second housing and the housing spacer, the recessed portion being fitted to the protruding portion in a direction of the rotational axis line and centering the second housing and the housing spacer with each other on the rotational axis line, wherein
in a case where the transmission is positioned at a position at which the protruding portion of the third fitting portion and the recessed portion of the third fitting portion start fitting to each other, the rotary portion of the transmission is away from a position at which the rotary portion starts fitting to the output shaft portion of the power source by a predetermined distance.

2. The joining structure according to claim 1, wherein the protruding portion of the third fitting portion corresponds to a dowel pin and the recessed portion of the third fitting portion corresponds to a pin hole fitted to the dowel pin.

3. The joining structure according to claim 1, wherein the joining structure allows the transmission to be joined to a plurality of types of power sources and the housing spacer corresponds to a first adapter provided for each of the types of the power sources, the joining structure further comprising:
a second adapter fixed to an output shaft of the power source and provided with the output shaft portion, the second adapter being provided for each of the types of the power sources.

4. The joining structure according to claim 3, wherein
the second adapter includes a first fixing portion fixing a drive plate fastened to the rotary portion of the transmission and a second fixing portion fixed to the output shaft of the output shaft portion, and
the first fixing portion and the second fixing portion are provided at positions which are different from each other in a radial direction of the transmission.

5. The joining structure according to claim 3, wherein
the second adapter includes a first fixing portion fixing a drive plate fastened to the rotary portion of the transmission and a second fixing portion fixing a flywheel,
the flywheel and the output shaft of the output shaft portion are fixed to each other at a third fixing portion, and
the first fixing portion, the second fixing portion and the third fixing portion are provided at positions which are different from one another in a radial direction of the transmission.

6. The joining structure according to claim 4, wherein the rotary portion of the transmission includes a front cover expanding in the axial direction during rotation and the first fixing portion is provided to face a concave portion formed at the front cover.

7. The joining structure according to claim 3, wherein
the protruding portion of the third fitting portion corresponds to a partial spigot joint flange and the recessed portion of the third fitting portion corresponds to a spigot joint hole fitted to the partial spigot joint flange, and
the partial spigot joint flange is provided at two positions of the first adapter which are symmetrical to each other in a circumferential direction.
